(19) United States
(12) Patent Application Publication
(10) Pub. No.: US 2007/0293282 A1
(43) Pub. Date: Dec. 20, 2007

(54) Metal cover assembly

(75) Inventors: Ian Lewis, Coquitlam (CA); Nina Hamalainen, Vancouver (CA)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/453,569

(22) Filed: Jun. 14, 2006

(51) Int. Cl. H04M 1/00

(52) U.S. Cl. 455/575.1

(57) ABSTRACT

A cover assembly comprises an outer metal frame and an inner metal frame in a nested configuration. A window plate is trapped between these two frames such that the frames do not take away much of the window area. The two metal frames can be fixed in place by spot welding using a laser or the like. As such, the assembly does not require tape adhesive or ultra-sonic welding to fix in place. A plurality of clips and hooks extended from the inner metal frame for providing grounding to a device that uses the cover assembly.

### FIELD OF THE INVENTION

The present invention relates generally to a metal cover assembly and, more particularly, to a cosmetic cover assembly for use on a smaller communication device.

### BACKGROUND OF THE INVENTION

Cosmetic covers, known as cosmetic A-Cover assemblies, have become increasing popular for use in a portable electronic device, such as a mobile phone. As mobile phones and other portable electronic devices become thinner and thinner, it is advantageous and desirable to provide a cosmetic A-Cover that is thin yet strong. Furthermore, when the cosmetic A-Cover is used in a telecommunication device, it is necessary to provide proper grounding in the cover.

### SUMMARY OF THE INVENTION

The present invention provides a cover assembly that comprises an outer metal frame and an inner metal frame in a nested configuration. A window plate is trapped between these two frames such that the frames do not take away much of the window area. The two metal frames can be fixed in place by spot welding using a laser or the like. As such, the assembly does not require tape adhesive or ultra-sonic welding to fix in place. A number of metal clips and hooks can be made on one of the frames so that when the cover assembly is used on an electronic device, the frames can provide grounding to the electronic device.

Thus, the first aspect of the present invention provides a cover assembly which comprises:

a first metal frame and a second metal frame configured for a nested engagement in an overlapping orientation with the second frame nested inside the first frame, said overlapping orientation providing an overlapping open area, and

a window plate trapped between the two frames such that a part of the window plate covers at least a part of the overlapping open area.

The frames have one or more metal clips and hooks for engaging with another frame.

The second aspect of the present invention provides a method which comprises:

fitting a second metal frame inside a first metal frame in a nested engagement in an overlapping orientation, said overlapping orientation providing an overlapping open area;

disposing a window plate between the first and second method frames such that a part of the window plate covers at least a part of the overlapping open are; and

welding the second metal frame to the first metal frame at a number of discrete locations.

The method further comprises providing a crossbar on the second metal frame for pressing against part of the window plate.

The third aspect of the present invention provides an electronic device which comprises:

a device body with a body frame, a display module having a display area disposed inside the body frame, and a plurality of metal receiving couplers located on the body frame; and

a cover assembly having:
a first metal frame and a second metal configured for a nested engagement in an overlapping orientation for providing an overlapping open area,
a window plate trapped between the first and second frame, covering at least a part of the overlapping open area, and
a plurality of protruding members on the second frames, the protruding members dimensioned to engage with the receiving couplers so as to secure the cover assembly to the device body.

The present invention will become apparent upon reading the description taken in conjunction with FIGS. 1 to 3.

### BRIEF DESCRIPTION OF THE DRAWINGS

FIG. 1 is an exploded view of a metal cover assembly, according to an embodiment of the present invention.

FIG. 2 shows the under side of the metal cover assembly.

FIG. 3 shows an exploded view of an electronic device having a device body and a cover assembly, according to the present invention.

### DETAILED DESCRIPTION OF THE INVENTION

In a portable device such as a mobile phone or a communicator device, a large display window is highly desirable. Thus, a cover assembly for use in such a portable device should allow a maximum use of the display area. This means that the frame for the cover assembly should be as thin as it is practical and remain sufficiently strong. Furthermore, the cover assembly is required to provide necessary grounding to meet antenna performance.

To achieve the above objectives, the present invention provides a cover assembly that comprises an outer metal frame and an inner metal frame in a nested configuration. A window plate is trapped between these two frames such that the frames do not take away much of the window area. The two metal frames can be fixed in place by spot welding using a laser or the like. As such, the assembly does not require a piece of adhesive tape or ultra-sonic welding to fix in place.

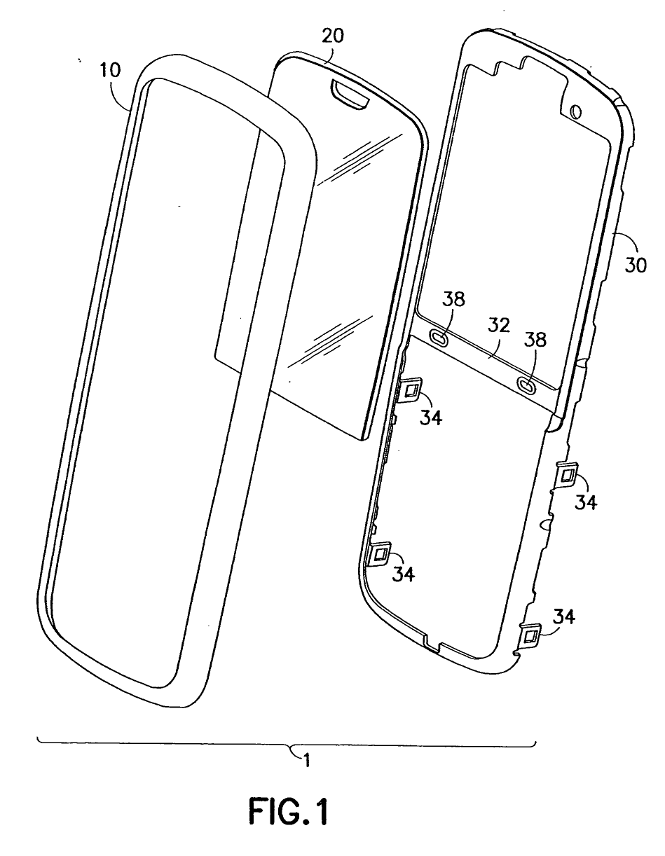

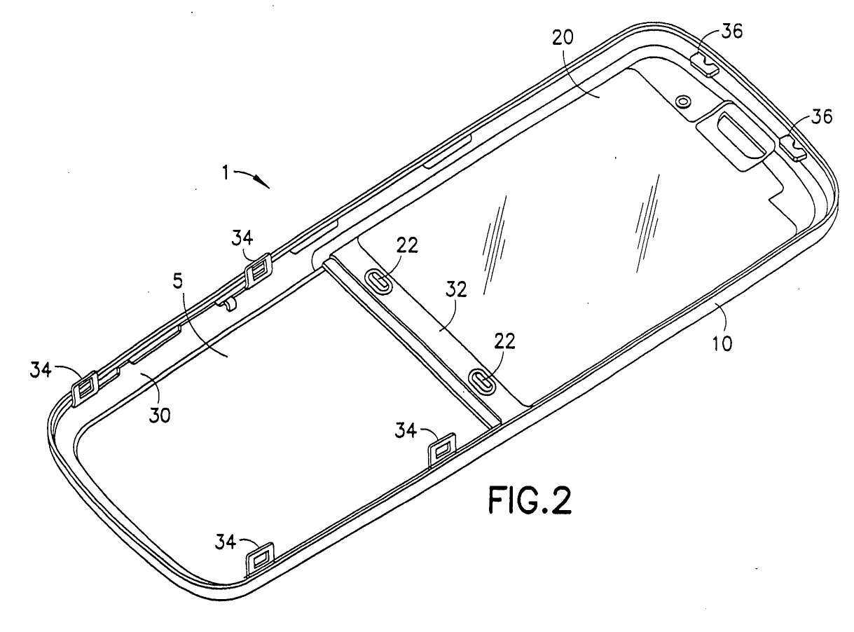

As shown in the exploded view in FIG. 1, the cover assembly 1 comprises three parts: an outer metal frame 10 which is also used as an outside cover, a window plate 20 and an inner metal frame 30 used as a metal support frame. The inner frame 30 has a crossbar 32 to add support to the window plate 20. A plurality of clips 34 and hooks 36 (see FIG. 2) so that the cover assembly can be assembled with a device body without the need of screws. As can be seen from FIGS. 1 and 2, the outer frame 10 and the inner frame 30 are configured for a nested engagement. The frame opening of the outer frame 10 and the frame opening of the inner frame 30 are substantially the same so that the overlapping open area 5 can be maximized. Part of the open area 5 is covered by the window plate 20. Such a structure allows for minimum land around a display active area under the window plate 20.

It is advantageous to make each of the outer frame 10 and the inner frame 30 a solid metal piece. As such, the frame can be made thin and strong. For example, both frames can be made of stainless steel. The thickness of the outer frame can be 0.5 mm and the inner frame can be 0.3 mm, for example. Furthermore, because both the outer and inner frames are made of metal, grounding for meeting the antenna requirement can be adequately provided.

Moreover, the window plate 20 is molded to have protruding members or pins 22 for engaging with the openings 38 on the crossbar 32. As such, there is no need to secure the window plate 20 with screws or a piece of adhesive tape.

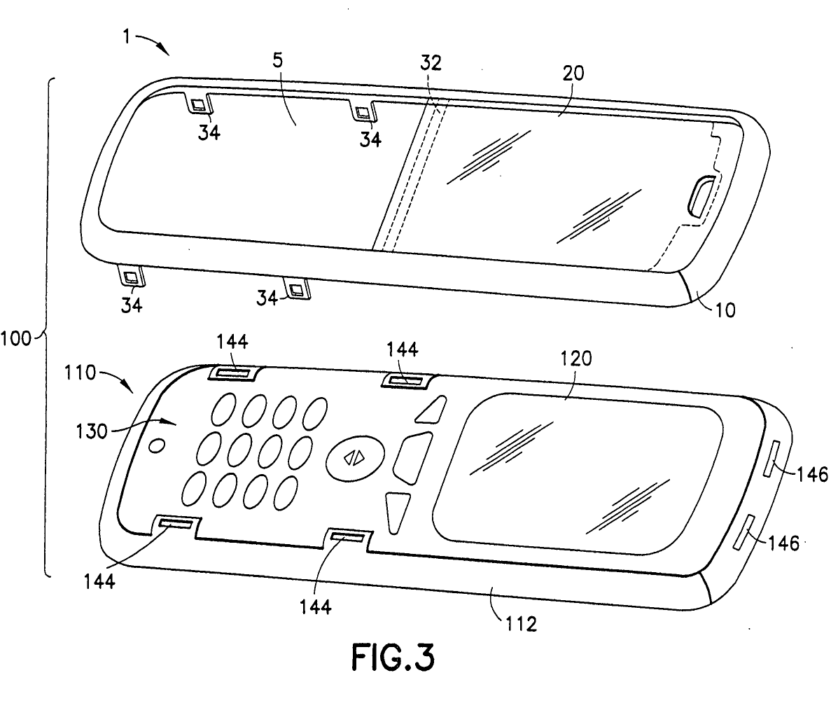

When the cover assembly 1 is designed for use on a portable device 100, as shown in FIG. 3, the crossbar 32 and the window plate 20 are dimensioned to fit the active display area 120 on the device body 110. The device body 110 has a body frame 112 and a plurality of metal receiving couplers 144,146 on the body frame 112. The clips 34 and the hooks 36 are positioned to fit the metal receiving couplers 144, 146. One or more of the receiving couplers 144 and 146 may have electrically conductive cables or strips operatively connected to an RF front end (not shown) in the device body 110. As such, the metal frames 10 and 30 of the cover assembly 1 can be used for providing grounding to the RF front end. The device body 110 may comprise a keypad 130 exposed through the frame opening 5 of the cover assembly, for example.

It should be noted that, in the cover assembly 1 as shown in FIGS. 1 to 3, the window plate 20 is located on one end of the frames 10 and 30. However, the window plate 20 can be located on a different location. Also, while it is preferred that both frames 10 and 30 are made of metals so that a metal joining process can be used to securely attach frame 30 to frame 10. However, it is also possible that only one of the frames 10, 30 is made of metal for grounding purposes. Furthermore, two or more window plates can be trapped between the two frames depending on the design and application. Moreover, the clips 34 and hooks 36 are shown as being extended from the inner frame 30. However, they can also be made on the outer frame 10.

The device 100 can be a mobile phone, a communication device, a PDA or the like.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A cover assembly, comprising:
a first frame,
a second frame, and
a window plate, wherein said first and second frames are configured for a nested engagement in an overlapping orientation with the second frame nested inside the first frame, said overlapping orientation providing an overlapping open area, and wherein said first and second frames are arranged to receive the window plate between the first and second frames such that a part of the window plate covers at least a part of the overlapping open area and at least one of the first and second frames is made of an electrically conducting material.

2. The cover assembly of claim 1, wherein the other of the first and second frames is made of an electrically conducting material so as to allow the second frame to be attached to the first frame by a metal joining process.

3. The cover assembly of claim 1, wherein the second frame has a first side and an opposing second side, the first side facing the first frame, and the second frame comprises a plurality of protruding members for mechanically engaged with a different frame.

4. The cover assembly of claim 1, wherein the second frame comprises a crossbar for pressing against part of the window plate.

5. The cover assembly of claim 5, wherein the second frame comprises a plurality of apertures on the crossbar and the window plate comprises a plurality of pins facing the second frame for engaging with the apertures.

6. A method, comprising:
fitting a second metal frame inside a first metal frame in a nested engagement in an overlapping orientation, said overlapping orientation providing an overlapping open area; and
disposing a window plate between the first and second method frames such that a part of the window plate covers at least a part of the overlapping open area.

7. The method of claim 6, further comprising:
welding the second metal frame to the first metal frame at a number of discrete locations.

8. The method of claim 6, wherein the second frame has a first side and an opposing second side, the first side facing the first frame, and the second frame comprises a plurality of protruding members for mechanically engaging with a different frame.

9. The method of claim 6, further comprising
providing a crossbar on the second metal frame for pressing against part of the window plate.

10. An electronic device, comprising:
a device body, comprising:
a body frame,
display module having a display area disposed inside the body frame, and
a plurality of metal receiving couplers located on the body frame; and
a cover assembly, comprising:
a first metal frame,
a second metal,
a window plate, and
a plurality of protruding members on the second frames, the protruding members dimensioned to engage with the receiving couplers so as to secure the cover assembly to the device body, wherein said first and second metal frames are configured for a nested engagement in an overlapping orientation with the second metal frame nested inside the first metal frame, said overlapping orientation providing an overlapping open area, and wherein said first and second metal frames are arranged to receive the window plate between the first and second frames such that a part of the window plate covers at least a part of the overlapping open area and the display area of the device body.

11. The electronic device of claim 10, wherein the first metal frame and the second metal frame are welded at a plurality of discrete areas for securing the second metal frame to the second metal frame.

12. The electronic device of claim 10, comprising a mobile terminal.
